(19) United States
(12) Patent Application Publication
(10) Pub. No.: US 2025/0029103 A1
(43) Pub. Date: Jan. 23, 2025

(54) SYSTEMS AND METHODS FOR AUTOMATED GEOLOCATION TAGGING FOR LOCATION COORDINATES IN CUSTOMER PROFILES

(71) Applicant: JPMORGAN CHASE BANK, N.A., New York, NY (US)

(72) Inventors: Jonathan ROSNER, White Plains, NY (US); Gerardo GEAN, Plano, TX (US); Raghu VUDATHU, Downingtown, PA (US)

(21) Appl. No.: 18/778,473

(22) Filed: Jul. 19, 2024

Related U.S. Application Data
(60) Provisional application No. 63/514,847, filed on Jul. 21, 2023.

(51) Int. Cl. G06Q 20/40

(52) U.S. Cl. CPC G06Q 20/4015

(57) ABSTRACT

Systems and methods for automated geolocation tagging for location coordinates in customer profiles are disclosed. A method may include: (1) receiving, at a safe space computer program and from a customer electronic device associated with a customer, safe space locations, wherein the safe space locations require a lower level of customer authentication than other locations; (2) receiving, by the safe space computer program and from the customer electronic device, a transaction; (3) determining, by the safe space computer program, the customer electronic device is in one of the safe space locations; and (4) authorizing, by the safe space computer program, the transaction with the lower level of customer authentication.

### RELATED APPLICATIONS

This application claims priority to, and the benefit of, U.S. Provisional Patent Application Ser. No. 63/514,847, filed Jul. 21, 2023, the disclosure of which is hereby incorporated, by reference, in its entirety.

### BACKGROUND OF THE INVENTION

### 1. Field of the Invention

Embodiments relate to systems and methods for automated geolocation tagging for location coordinates in customer profiles.

### 2. Description of the Related Art

One-time passwords (OTPs) sent by text (e.g. short messaging service, or SMS), email, phone, or other channels are commonly used as a mechanism to improve security by adding an extra layer of authentication to ensure that only authorized users can gain access to restricted systems. These one-time passwords are, however, susceptible to hacking.

### SUMMARY OF THE INVENTION

Systems and methods for automated geolocation tagging for location coordinates in customer profiles are disclosed. According to an embodiment, a method may include: (1) receiving, at a safe space computer program and from a customer electronic device associated with a customer, safe space locations, wherein the safe space locations require a lower level of customer authentication than other locations; (2) receiving, by the safe space computer program and from the customer electronic device, a transaction; (3) determining, by the safe space computer program, the customer electronic device is in one of the safe space locations; and (4) authorizing, by the safe space computer program, the transaction with the lower level of customer authentication.

In one embodiment, the safe space computer program receives a global positioning system location for each of the safe space locations.

In one embodiment, the step of determining, by the safe space computer program, the customer electronic device is in one of the safe space locations may include: receiving, by the safe space computer program, a global positioning system location for a current location for the customer electronic device; and determining, by the safe space computer program, that the global positioning system location for the current location for the customer electronic device is in one of the global positioning system locations for one of the safe space locations.

In one embodiment, the safe space computer program receives electronic environment information for each of the safe space locations.

In one embodiment, the electronic environment information may include an identification of cell towers that are in communication with the customer electronic device at the safe space location.

In one embodiment, the electronic environment information may include an identification of electronic devices connected to the customer electronic device at the safe space location.

In one embodiment, the electronic environment information may include computer network information for the safe space location.

In one embodiment, the step of determining, by the safe space computer program, the customer electronic device is in one of the safe space locations may include: receiving, by the safe space computer program, electronic environment information for a current location for the customer electronic device; and comparing, by the safe space computer program, the electronic environment information for the current location for the customer electronic device to the electronic environment information for each of the safe space locations. The customer electronic device is in one of the safe space locations when a threshold amount of the electronic environment information for the current location for the customer electronic device matches the electronic environment information for each of the safe space locations.

In one embodiment, the step of determining, by the safe space computer program, the customer electronic device is in one of the safe space locations may include: determining, by the safe space computer program, a confidence score that the customer electronic device is in one of the safe space locations. The confidence score may be based in part on a value of the transaction.

According to another embodiment, a system may include: a customer electronic device executing a customer computer program; and an electronic device executing a safe space computer program that may be configured to receive a plurality of safe space locations from the customer computer program, wherein the safe space locations require a lower level of customer authentication than other locations, to receive a transaction from the customer computer program, to determine that the customer electronic device is in one of the safe space locations, and to authorize the transaction with the lower level of customer authentication.

In one embodiment, the safe space computer program receives a global positioning system location for each of the safe space locations.

In one embodiment, the safe space computer program determines that the customer electronic device is in one of the safe space locations by receiving a global positioning system location for a current location for the customer electronic device, and determining that the global positioning system location for the current location for the customer electronic device is in one of the global positioning system locations for one of the safe space locations.

In one embodiment, the safe space computer program receives electronic environment information for each of the safe space locations, wherein the electronic environment information may include an identification of cell towers that are in communication with the customer electronic device at the safe space location, an identification of electronic devices connected to the customer electronic device at the safe space location, and/or computer network information for the safe space location.

In one embodiment, the safe space computer program determines that the customer electronic device is in one of the safe space locations by receiving electronic environment information for a current location for the customer electronic device, and comparing the electronic environment information for the current location for the customer electronic device to the electronic environment information for each of the safe space locations; wherein the customer electronic device is in one of the safe space locations when a threshold amount of the electronic environment information for the current location for the customer electronic device matches the electronic environment information for each of the safe space locations.

In one embodiment, the safe space computer program determines that the customer electronic device is in one of the safe space locations by determining a confidence score that the customer electronic device is in one of the safe space locations, wherein the confidence score may be based in part on a value of the transaction.

According to another embodiment, a non-transitory computer readable storage medium, including instructions stored thereon, which when read and executed by one or more computer processors, cause the one or more computer processors to perform steps comprising: receiving from a customer electronic device associated with a customer, safe space locations, wherein the safe space locations require a lower level of customer authentication than other locations; receiving a transaction from the customer electronic device; determining that the customer electronic device is in one of the safe space locations; and authorizing the transaction with the lower level of customer authentication.

In one embodiment, the step of determining that the customer electronic device is in one of the safe space locations includes instructions stored thereon, which when read and executed by the one or more computer processors, cause the one or more computer processors to perform steps comprising: receiving a global positioning system location for a current location for the customer electronic device; and determining that the global positioning system location for the current location for the customer electronic device is in one of the global positioning system locations for one of the safe space locations.

In one embodiment, electronic environment information is received for each of the safe space locations, wherein the electronic environment information may include an identification of cell towers that are in communication with the customer electronic device at the safe space location, an identification of electronic devices connected to the customer electronic device at the safe space location, and/or computer network information for the safe space location.

In one embodiment, the step of determining that the customer electronic device is in one of the safe space locations includes instructions stored thereon, which when read and executed by the one or more computer processors, cause the one or more computer processors to perform steps comprising: receiving electronic environment information for a current location for the customer electronic device; and comparing the electronic environment information for the current location for the customer electronic device to the electronic environment information for each of the safe space locations. The customer electronic device is in one of the safe space locations when a threshold amount of the electronic environment information for the current location for the customer electronic device matches the electronic environment information for each of the safe space locations.

In one embodiment, the step of determining that the customer electronic device is in one of the safe space locations includes instructions stored thereon, which when read and executed by the one or more computer processors, cause the one or more computer processors to perform steps comprising: determining a confidence score that the customer electronic device is in one of the safe space locations, and the confidence score may be based in part on a value of the transaction.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for automated geolocation tagging for location coordinates according to an embodiment;

FIG. 2 depicts a method for automated geolocation tagging for location coordinates in customer profiles according to an embodiment;

FIG. 3 depicts an exemplary computing system for implementing aspects of the present disclosure.

### DETAILED DESCRIPTION OF PREFERRED EMBODIMENTS

Embodiments relate to systems and methods for automated geolocation tagging for location coordinates in customer profiles.

Embodiments address authentication, third-party vendors, and partnerships, at which point authentication triggers the ecosystem.

Although location determination using global positioning system data may be used, this data does not always produce accurate results. Thus, embodiments may use geofencing for customers to help with security and authentication. For example, a customer may enroll certain spaces where the customer conducts transactions, such as the customer's home, work, school, vacation home, etc. as safe space locations, and may establish geofences for those locations. Electronic environment information, such as the identities of other electronic devices connected to or in communication with the customer's electronic device, such as routers, Internet of Things (IoT) devices, peripherals (e.g., printers), other mobile devices, beacons, cell tower identities, etc. Identifiers, such as device identifiers, MAC addresses, etc., as well as signal strengths, networks (e.g., SSIDs), etc. may also be captured.

In one embodiment, the customer may be asked to grant permission to access information one time, such as location information, during safe space enrollment. The customer may later disable the option to share the location information after enrollment.

During authentication and/or during sensitive transactions (e.g., performing a wire transfer above a certain dollar amount), the current location and/or electronic environment information for the customer's electronic may be captured and may be compared to location and/or electronic environment information for the customer's enrolled safe space location(s). If the comparison by, for example, a computer program, yields a confidence score above a threshold that the customer electronic device is in an enrolled safe space location (e.g., a certain level of matching of the customer electronic device location with the stored location for the safe space location, and/or a certain level of matching of the current electronic environment information with the stored electronic environment information), a lower authentication threshold may be used.

In one embodiment, the threshold may be dynamic and may be based on the type of transaction, the value of the transaction, etc.

In one embodiment, the customer may set a geofence for the safe space location. For example, the geofence may be defined as a radius of several feet, or as otherwise necessary and/or desired.

In embodiments, a financial institution issuer may use the enrolled safe space locations to determine where high transaction risks occur.

In one embodiment, the financial institution issuer may suggest that the customer enroll a location as a safe space location if the customer frequently conducts transactions from that location, and the location has not been enrolled.

In one embodiment, the issuer may assign certain locations, such as branches as safe space locations for its customers.

In one embodiment, the customer may also unenroll a safe space location if it is no longer used for transactions (e.g., the customer moves, changes jobs, etc.).

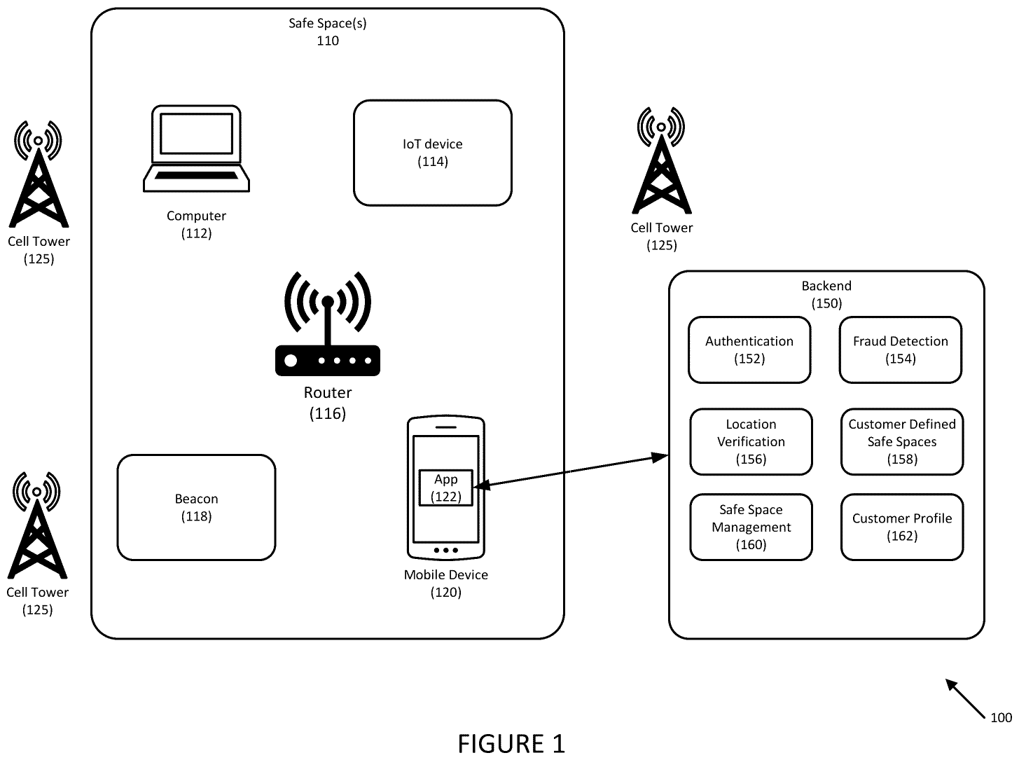

FIG. 1 depicts a system for automated geolocation tagging for location coordinates according to an embodiment. System 100 may include safe space location 110, which may be a location identified by a user as an area that is trusted by the user. Examples of such areas may include the user's home or vacation home location, the user's work location, a trusted branch location, etc.

Safe space location 110 may include one or more of the following devices—computer 112, which may be a laptop, desktop, notebook, tablet, etc., that may be associated with the user or a family member of the user; Internet of Things (IoT) device 114, router 116, beacon 118, mobile device 120 (e.g., smart phone, smart watch, etc.), etc. Mobile device 120 may execute one or more applications 122, including an application that may communicate with backend 150.

Application 122 may provide location information to backend 150. Application 122 may provide, for example, GPS location data for mobile device 120, network information (e.g., identification of WiFi networks, Bluetooth networks, equipment in safe space location 110, etc.). In another embodiment, mobile device 120 may further provide information for one or more cell towers 125.

Backend 150 may include service such as authentication services 152, fraud detection services 154, location verification services 156, safe space management services 160, etc. Backend 150 may also store information on customer defined safe spaces 158 and may also store a customer profile in customer profile database 162.

The user may identify safe space locations 110 to safe space management service 160 using application 122. The user may provide a location for safe space location 110, such as a GPS location, as well as information on the area, including information on cell towers 125, WiFi and Bluetooth networks (e.g., network identifiers, signal strengths, etc.), equipment identifiers (e.g., MACs) for electronic devices, etc. The user may also provide any time information being in safe space location 110, such as days of the week, hours of the day, etc. For example, a user may specify that a work safe space location is a safe space during the workday, but not at night.

The user may also specify permissions or restrictions on the safe space locations 110. For example, when in a safe space location, there may be no restrictions on the types of transactions, transaction limits, etc. When not in a safe space location, however, additional verification (e.g., out of band verification, two factor authentication, step up biometric authentication, etc.) may be required.

In one embodiment, safe space management service 160 may store the permissions or restrictions in customer profile database 162.

Location verification services 156 may receive location information from application 122, and may compare the location to the stored safe space locations in customer defined safe spaces 158.

Authentication services 152 may provide authentication services using, for example, information provided by application 122. Application 122 may share certain information, such as a device identifier, location, IP address, MAC address, and other device specific details with the authentication system. This will be the first level of location detection.

Fraud detection services 154 may use the information provided by location verification services 156 in its fraud algorithms.

In embodiment, for each safe space location 110, certain limits, such as a maximum dollar amount, a maximum number of transactions, etc. may be set, such that an attempted transaction that exceeds the limit will be declined.

In one embodiment, application 122 may function as a beacon device for other users that may be located within one of the safe space locations 110. For example, if one user is performing a transaction, and another user is located in the same safe space location 110, application 122 may act as a beacon to confirm the location accuracy and proximity of mobile device 120.

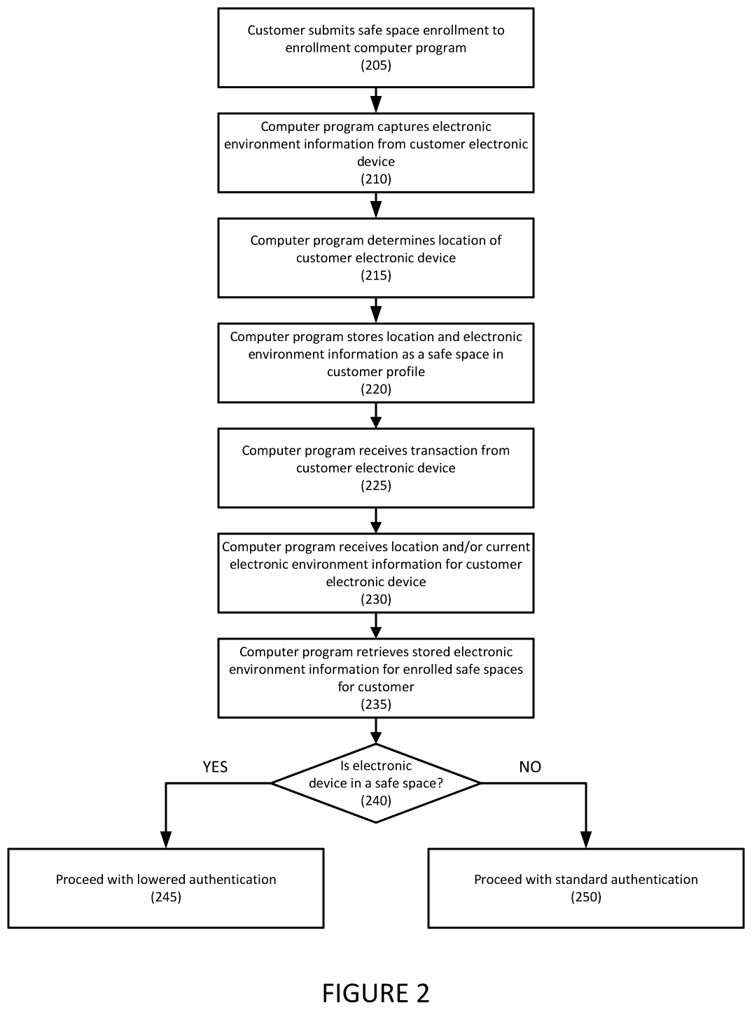

Referring to FIG. 2, a method for automated geolocation tagging for location coordinates in customer profiles according to an embodiment.

In step 205, a customer may submit a safe space enrollment request to, for example, a safe space computer program. The safe space computer program may be provided by a financial institution, a third party, etc. and may provide safe space enrollment functionality and safe space verification functionality.

The enrollment computer program may be provided as part of a computer or a mobile application for a financial institution, may be accessed through a browser, device app store, etc.

In one embodiment, the customer may authenticate to the computer program using, for example, biometric authentication, out-of-band authentication, etc.

To define a particular location as a safe space location, the customer may log into a computer application on the customer's electronic device, such as that for a financial institution, and may use an enrollment functionality by selecting a button such as “Add this location as a Safe Space.” In embodiments, by clicking the button, the customer gives consent to gather the location information and the electronic environment information from the customer electronic device. The collected information may then be captured and relevant information from the location may then be stored in a customer profile, such as a customer-digital-electronic-equipment-network-profile in a database for, for example, the financial institution. The customer may update the location information and/or electronic environment information as is necessary and/or desired by selecting a refresh option.

In step 210, the computer program may capture electronic environment information from the customer electronic device. In one embodiment, the customer may be asked to allow the computer program to access the electronic environment information on the customer electronic device.

For example, the computer program may retrieve an identification of cell towers that are in communication with the customer electronic device. This may be done using, for example, “Field Test Mode.” Using the nearby tower identification, the computer program may retrieve details for the identified nearby cell towers using one or more of the (a) tower location, (b) signal strength reading, (c) tower ID, (d) tower geographic coordinates, (e) location distance, and/or (f) signal strength measurements, crowd sourced location, etc.

The computer program may then retrieve electronic environment information for the customer electronic device and its connections. For example, the computer program may retrieve information on the router that the customer electronic device is connected to (e.g., device identifier, MAC address, etc.), the Wi-Fi ID or SSID, the Wi-Fi signal strength, the customer electronic device ID, MAC address, the International Mobile Electronic Identity (IMEI), any connected beacon identifiers (e.g., for beacons that may be provided by the issuer or third party), device identifiers/MAC addresses for any IoT devices that are connected to the mobile electronic device, device identifiers/MAC addresses for any electronic devices connected by Bluetooth, device identifiers/MAC addresses for any other electronic devices on the same network (e.g., printers, switches, etc.), etc. Any other electronic environment information may be collected as is necessary and/or desired.

In step 215, the computer program may determine the location of the customer electronic device. In one embodiment, the computer program may use cell tower triangulation to determine the location. In another embodiment, GPS data may be used to determine the location. In still another embodiment, a combination of triangulation and GPS data may be used.

The computer program may also determine the mobile electronic device location using SDKs, and may compare it to the device location obtained from the tower location or GPS data to verify the accuracy of the triangulation.

In step 220, the computer program may store the location and the electronic environment information as a safe space location in a customer profile.

In step 225, the computer program may receive a transaction from the customer electronic device. The transaction may be a financial transaction, a purchase, etc.

In step 230, the computer program may receive current location and/or current electronic environment information for the customer electronic device. For example, the computer program may receive some of all of the electronic environment information that is stored in the customer profile as, for example, a customer-digital-electronic-equipment-network-profile-identifier.

In one embodiment, the amount of electronic environment information received may depend on the permissions granted by the customer for sharing information. For example, the customer may not grant permission to access the current location information from the customer electronic device. Thus, if the current location information is not available, the computer program may consider the other electronic environment information.

In step 235, the computer program may retrieve the stored electronic environment information for enrolled safe space locations for the customer from the customer profile.

In step 240, the computer program may determine whether the customer electronic device is in a safe space location. This may be done by comparing the current location and/or current electronic environment information to the stored location and/or stored electronic environment information for the safe space locations. It should be noted that not all electronic environment information may be available; for example, the customer may not be connected to Wi-Fi, SSID networks may have changed, additional cell towers may have been added, etc. Thus, the computer program may generate a confidence score based on a comparison of the available current information to the stored information.

In one embodiment, the threshold for the confidence score may be dynamic and may be based on the value of the transaction, the time of day, etc.

In step 245, if the confidence score is above the threshold, indicating a high confidence that the customer electronic device is in a safe space location, the computer program may proceed with a lower level of customer authentication. In one embodiment, the customer's profile may be updated to include any additions or changes to the electronic environment information.

An example of a lower level of authentication is authenticating to the mobile application. The lower level of authentication reduces or eliminates friction created by the financial institution when wire transferring large amounts of money. An example of a higher level of authentication is asking the customer to call the financial institution's customer service and authenticate using a code, OTP, etc. before performing the wire transfers of large amounts of money.

In step 250, if the confidence score is below the threshold, indicating a low confidence that the customer electronic device is in a safe space location, the computer program may proceed with a standard or heightened level of customer authentication.

In one embodiment, the safe space location information may be provided to a fraud system and may be used for fraud decisioning.

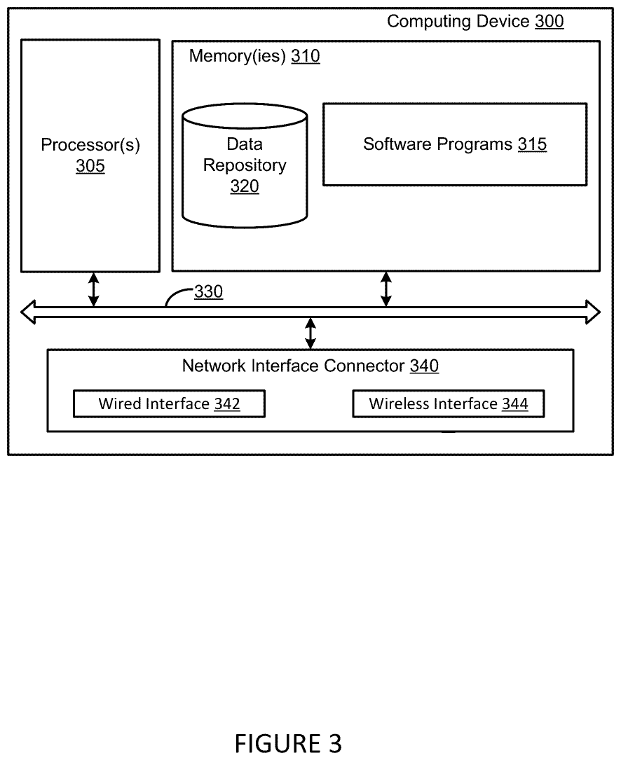

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope. Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, at a safe space computer program and from a customer electronic device associated with a customer, safe space locations, wherein the safe space locations require a lower level of customer authentication than other locations;
receiving, by the safe space computer program and from the customer electronic device, a transaction;
determining, by the safe space computer program, the customer electronic device is in one of the safe space locations; and
authorizing, by the safe space computer program, the transaction with the lower level of customer authentication.

2. The method of claim 1, wherein the safe space computer program receives a global positioning system location for each of the safe space locations.

3. The method of claim 2, wherein the step of determining, by the safe space computer program, the customer electronic device is in one of the safe space locations comprises:
receiving, by the safe space computer program, a global positioning system location for a current location for the customer electronic device; and
determining, by the safe space computer program, that the global positioning system location for the current location for the customer electronic device is in one of the global positioning system locations for one of the safe space locations.

4. The method of claim 1, wherein the safe space computer program receives electronic environment information for each of the safe space locations.

5. The method of claim 4, wherein the electronic environment information comprises an identification of cell towers that are in communication with the customer electronic device at the safe space location.

6. The method of claim 4, wherein the electronic environment information comprises an identification of electronic devices connected to the customer electronic device at the safe space location.

7. The method of claim 4, wherein the electronic environment information comprises computer network information for the safe space location.

8. The method of claim 4, wherein the step of determining, by the safe space computer program, the customer electronic device is in one of the safe space locations comprises:
receiving, by the safe space computer program, electronic environment information for a current location for the customer electronic device; and
comparing, by the safe space computer program, the electronic environment information for the current location for the customer electronic device to the electronic environment information for each of the safe spaces;
wherein the customer electronic device is in one of the safe space locations when a threshold amount of the electronic environment information for the current location for the customer electronic device matches the electronic environment information for each of the safe spaces.

9. The method of claim 1, wherein the step of determining, by the safe space computer program, the customer electronic device is in one of the safe space locations comprises:
determining, by the safe space computer program, a confidence score that the customer electronic device is in one of the safe space locations;
wherein the confidence score is based in part on a value of the transaction.

10. A system, comprising:
a customer electronic device executing a customer computer program; and
an electronic device executing a safe space computer program that is configured to receive a plurality of safe space locations from the customer computer program, wherein the safe space locations require a lower level of customer authentication than other locations, to receive a transaction from the customer computer program, to determine that the customer electronic device is in one of the safe space locations, and to authorize the transaction with the lower level of customer authentication.

11. The system of claim 10, wherein the safe space computer program receives a global positioning system location for each of the safe space locations.

12. The system of claim 11, wherein the safe space computer program determines that the customer electronic device is in one of the safe space locations by receiving a global positioning system location for a current location for the customer electronic device, and determining that the global positioning system location for the current location for the customer electronic device is in one of the global positioning system locations for one of the safe space locations.

13. The system of claim 10, wherein the safe space computer program receives electronic environment information for each of the safe space locations, wherein the electronic environment information comprises an identification of cell towers that are in communication with the customer electronic device at the safe space location, an identification of electronic devices connected to the customer electronic device at the safe space location, and/or computer network information for the safe space location.

14. The system of claim 13, wherein the safe space computer program determines that the customer electronic device is in one of the safe space locations by receiving electronic environment information for a current location for the customer electronic device, and comparing the electronic environment information for the current location for the customer electronic device to the electronic environment information for each of the safe spaces; wherein the customer electronic device is in one of the safe space locations when a threshold amount of the electronic environment information for the current location for the customer electronic device matches the electronic environment information for each of the safe spaces.

15. The system of claim 10, wherein the safe space computer program determines that the customer electronic device is in one of the safe space locations by determining a confidence score that the customer electronic device is in one of the safe space locations, wherein the confidence score is based in part on a value of the transaction.

16. A non-transitory computer readable storage medium, including instructions stored thereon, which when read and executed by one or more computer processors, cause the one or more computer processors to perform steps comprising:
receiving from a customer electronic device associated with a customer, safe space locations, wherein the safe space locations require a lower level of customer authentication than other locations;
receiving a transaction from the customer electronic device;
determining that the customer electronic device is in one of the safe space locations; and
authorizing the transaction with the lower level of customer authentication.

17. The non-transitory computer readable storage medium of claim 16, wherein the step of determining that the customer electronic device is in one of the safe space locations includes instructions stored thereon, which when read and executed by the one or more computer processors, cause the one or more computer processors to perform steps comprising:
receiving a global positioning system location for a current location for the customer electronic device; and
determining that the global positioning system location for the current location for the customer electronic device is in one of the global positioning system locations for one of the safe space locations.

18. The non-transitory computer readable storage medium of claim 16, electronic environment information is received for each of the safe space locations, wherein the electronic environment information comprises an identification of cell towers that are in communication with the customer electronic device at the safe space location, an identification of electronic devices connected to the customer electronic device at the safe space location, and/or computer network information for the safe space location.

19. The non-transitory computer readable storage medium of claim 16, wherein the step of determining that the customer electronic device is in one of the safe space locations includes instructions stored thereon, which when read and executed by the one or more computer processors, cause the one or more computer processors to perform steps comprising:
receiving electronic environment information for a current location for the customer electronic device; and
comparing the electronic environment information for the current location for the customer electronic device to the electronic environment information for each of the safe spaces;
wherein the customer electronic device is in one of the safe space locations when a threshold amount of the electronic environment information for the current location for the customer electronic device matches the electronic environment information for each of the safe spaces.

20. The non-transitory computer readable storage medium of claim 16, wherein the step of determining that the customer electronic device is in one of the safe space locations includes instructions stored thereon, which when read and executed by the one or more computer processors, cause the one or more computer processors to perform steps comprising:
determining a confidence score that the customer electronic device is in one of the safe space locations;
wherein the confidence score is based in part on a value of the transaction.
